(19) United States
(12) Patent Application Publication
(10) Pub. No.: US 2014/0341280 A1
(43) Pub. Date: Nov. 20, 2014

(54) MULTIPLE REGION VIDEO CONFERENCE ENCODING

(71) Applicants: Liu Yang, Beijing (CN); Bin Wang, Beijing (CN)

(72) Inventors: Liu Yang, Beijing (CN); Bin Wang, Beijing (CN)

(21) Appl. No.: 13/997,867

(22) PCT Filed: Dec. 18, 2012
(86) PCT No.: PCT/CN2012/086805

§ 371 Date: Jun. 25, 2013

(51) Int. Cl. H04N 19/23; H04N 7/15

(52) U.S. Cl. CPC H04N 19/004; H04N 7/15
USPC 375/240.08

(57) ABSTRACT

Systems and method may provide for a computing device that encodes multiple regions of a video frame at different quality levels. In particular, a first region of one or more frames containing a speaker's face may be located and encoded at a first quality level. A second region containing a background, on the other hand, may be located and encoded at a second quality level. Optionally a third region containing additional faces may be located and encoded at a third quality level and a fourth region may be located and encoded at a fourth quality level.

### BACKGROUND

The communication quality of video conference applications may rely heavily on the real time status of a network. Many current video conference systems introduce complicated algorithms to smooth network disturbance(s) caused by, among other things, the unmatched bit-rate between what the video conference application generates and a networks ability to process streamed data. However, these algorithms may bring extra complexity to conferencing systems and still fail to perform well under environments where the communication quality may be significantly restricted by limited available bandwidth. Examples of such environment include: mobile communications networks, rural communications networks, combinations thereof, and/or the like. What is needed is a way to decrease the bit-rate of a video conference without sacrificing the quality of important information in a video frame.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 illustrates an example video conferencing scheme as per an aspect of an embodiment of the present invention;

FIG. 2A illustrates an example video frame with various identified entities and objects as per an aspect of an embodiment of the present invention;

FIG. 2B illustrates the example video frame with various identified regions as per an aspect of an embodiment of the present invention;

FIGS. 3A and 3E illustrate the example video frame with various identified regions as per an aspect of an embodiment of the present invention;

FIGS. 4 and 5 are a block diagrams of an example multiple region video conference encoders as per an aspect of an embodiment of the present invention;

FIG. 6 is a flow diagram of an example multiple region video conference as per an aspect of an embodiment of the present invention;

FIGS. 7-9 are example flow diagrams of a video conference encoding mechanism as per an aspect of an embodiment of the present invention; and

FIGS. 10 and 11 are illustrations of an embodiment of the present invention.

### DETAILED DESCRIPTION

Embodiments of the present invention may decrease the bit-rate of a video conference without sacrificing the quality of important information in a video frame by encoding different regions of the video frame at different quality levels. For example, it may be determined that the most important part of a frame is a speaker's face. In such a case, embodiments may encode a region of the frame that includes the speaker's face at a higher quality than the rest of the video frame. This selective encoding may result in a smaller frame size that may safely decrease the bit-rate of the video conference stream.

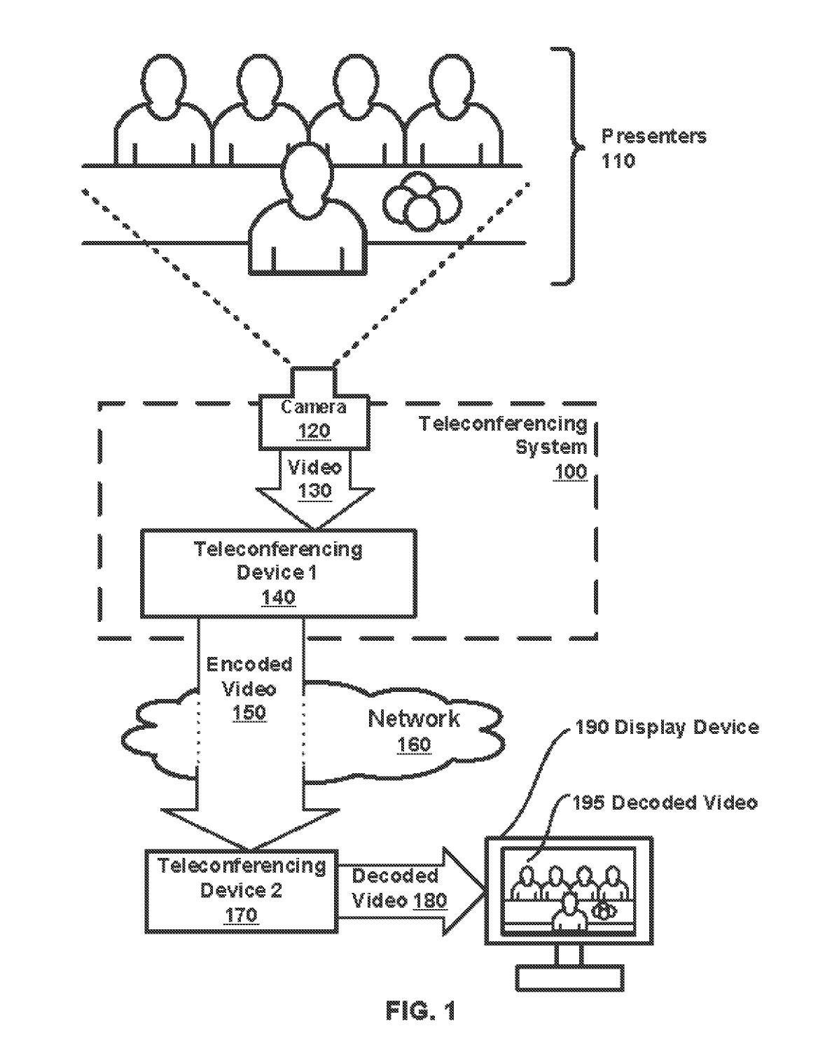

An example video conference is illustrated in FIG. 1. In this example video conference, a camera 120 may capture a video 130 of group of presenters 110. The video 130 may then be input and processed by a teleconferencing device 140. The teleconferencing device 140 may be, for example: a computer system with an attached and/or integrated camera; a discrete teleconferencing device, a combination thereof; and/or the like. In some embodiments, the camera 120 may be integrated with the teleconferencing device 140 forming a teleconferencing system 100.

The teleconferencing device 140 may generate an encoded video signal 150 from video 130 using a codec, wherein a codec can be a device or a computer program running on a computing device that is capable of encoding a video for storage, transmission, encryption, decoding for playback or editing, a combination thereof, and/or the like. Codecs, as per certain embodiments, may be designed and/or configured to emphasize certain regions of the video over other regions of the video. Examples of available codecs include, but are not limited to: Dirac available from the British Broadcast System; Blackbird available from Forbidden Technologies PLC; DivX available from DivX, Inc.; Neo Digital available from Nero AG; ProRes available from Apple Inc.; and VP8 available from On2 Technologies. Many of the Codecs use compression algorithm such as MPEG-1, MPEG-2, MPEG-4 ASP, H.261, H.263, VC-3, WMV7, WMV8, MJPEG, MPEG-4v3, and DV.

Video codecs rate control strategies may use variable bit rate (VBR) and constant bit rate (CBR) rate control strategies. Variable bit rate (VBR) is a strategy to maximize the visual video quality and minimize the bit rate. For example, on fast motion scenes, a triable bit rate may use more bits than it does on slow motion scenes of similar duration yet achieve a consistent visual qualify. For real-time and non-buffered video streaming when the available bandwidth may be fixed, (e.g. in video conferencing delivered on channels of fixed band width), a constant bit rate (CBR) may be used. CBR may be used for applications such as video conferencing, satellite and cable broadcasting, combinations thereof, and/or the like.

The quality that the codec may achieve may be affected by the compression format the codec uses. Multiple codecs may implement the same compression specification. For example, MPEG-1 codecs typically do not achieve quality/size ratio comparable to codecs that implement the more modern H.264 specification. However, the quality/size ratio of output produced by different implementations of the same specification may also vary.

Encoded video 150 may be transported through a network to a second teleconferencing device. The network may be a local network (e.g. an intranet), a basic communications network (e.g. a POTS (plain old telephone system)), an advanced telecommunications system (e.g. a satellite relayed system), a hybrid mixed network, the internet, and/or the like. The teleconferencing device 170 may be similar to the teleconferencing device 140. However, in this example, teleconferencing device 140 may need to have a decoder compatible with the codec. A decoder may be a device or software operating in combination with computing hardware which does the reverse operation of an encoder, undoing the encoding so that the original information can be retrieved. In this case, the decoder may need to retrieve the information encoded by teleconferencing device 140.

The encoder and decoder in teleconferencing devices 140 and 170 may be endecs. An endec may be a device that acts as both an encoder and a decoder on a signal or data stream, either with the same or separate circuitry or algorithm. In some literature, the term codec is used equivalently to the term endec. A device or program running in combination with hardware which uses a compression algorithm to create MPEG audio and/or video is often called an encoder, and one which plays back such files is often called a decoder. However, this may also often called be a codec.

The decoded video 180 may be communicated from teleconferencing devices 170 to a display device 190 to present the decoded video 195. The display device may be a computer, a TV, a projector, a combination thereof, and/or the like.

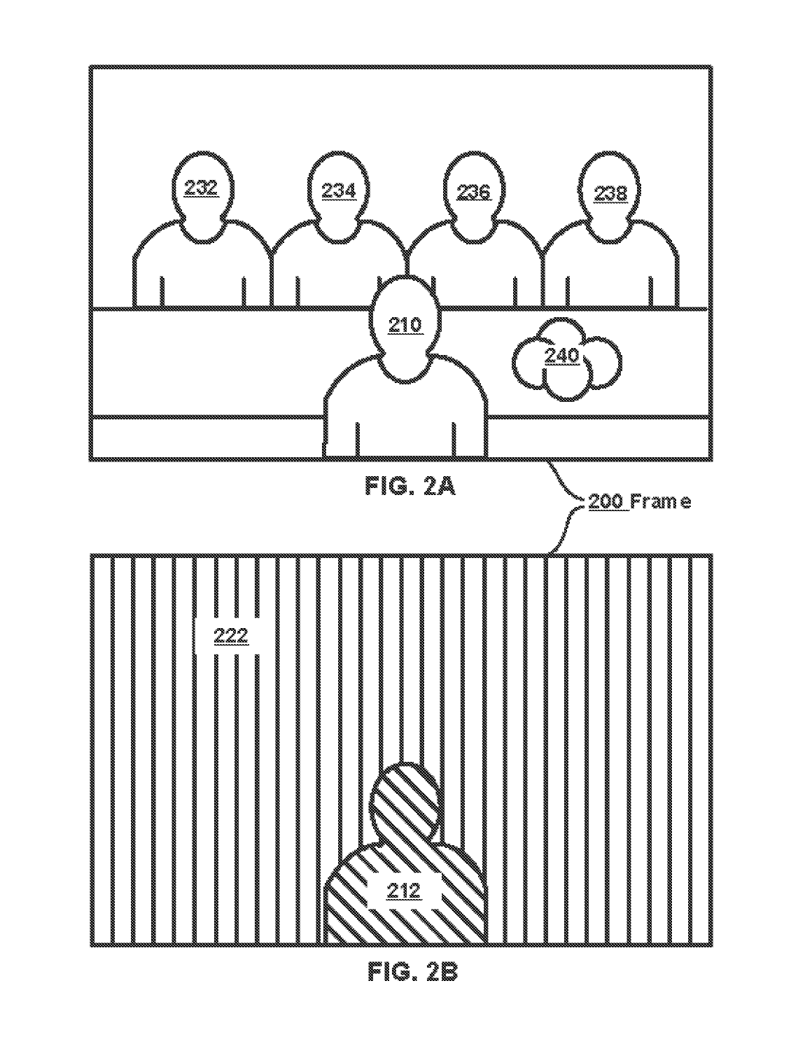

FIG. 2A illustrates an example video frame 200 with various identified entities (210, 232, 234, 236, and 238), and objects (240) as per an aspect of an embodiment of the present invention. As shown in this illustration, FIG. 210 in the foreground is a primary speaker. Entities 232, 234, 236, and 238 are additional participants. Object(s) 240 are additional item(s) that may be important for demonstrative purposes during a teleconference.

FIG. 2B illustrates the video frame with various regions as per an aspect of an embodiment of the present invention. In this illustration, an area covering a speaker may be identified as a first region 212 and the remainder of the frame (the background) may be identified as a second region 222.

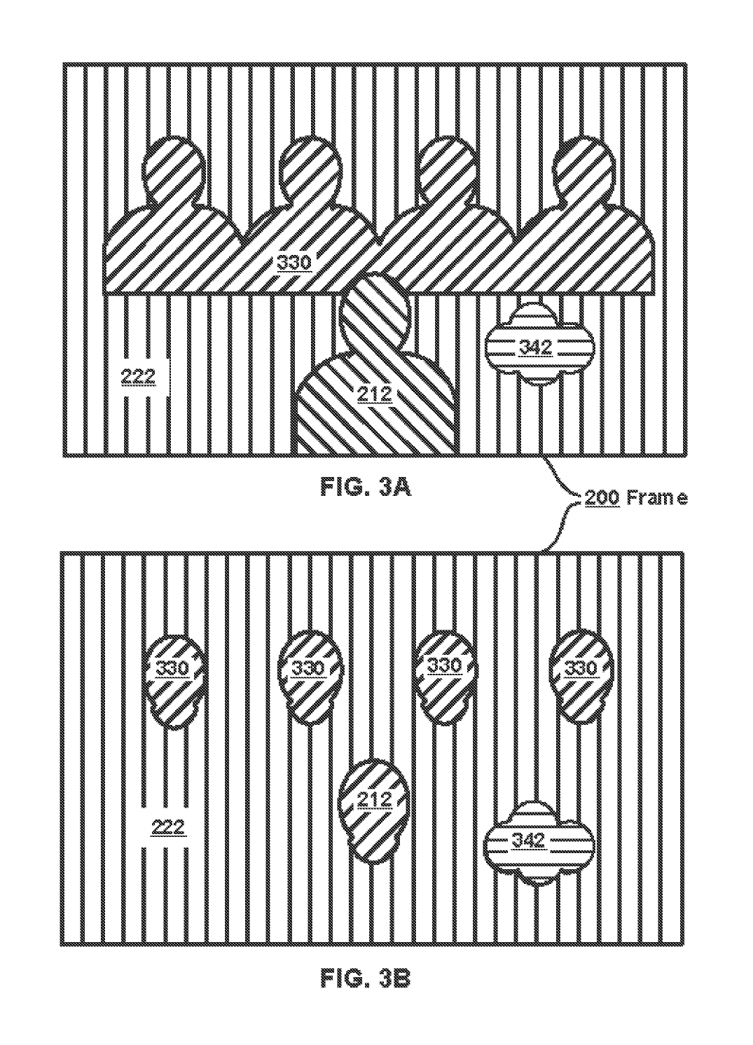

FIG. 3A and FIG. 3B illustrate the video frame with various alternative regions identified. In FIG. 3A, an area covering a speaker may be identified as a first region 212, an area covering additional entities/participants 232, 234, 236, and 238 (FIG. 2A) may be identified as a third region 330, an area covering object(s) 240 may be identified as a fourth region 342 and the remainder of the frame (the background) may be identified as a second region 222. The regions may vary in size. For example, in FIG. 3A, the first region 212 includes the speaker and a portion of the speaker's exposed body. However, in FIG. 3B, the first region 212 includes only the speaker's head. Similarly, in FIG. 3A, the third region 330 includes the additional participants and a portion of the additional participants' exposed bodies. In FIG. 3B, however, the third region 330 includes only the additional participants' heads.

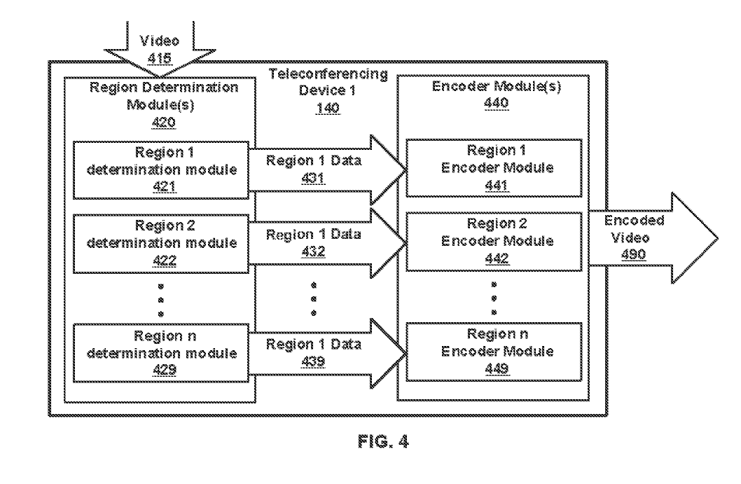

According to some of the various embodiments, region discrimination may be performed by teleconferencing device 140. FIG. 4 is a block diagram of a multiple region video conference encoder as per an aspect of an embodiment of the present invention. The teleconferencing device 140 may include one or more region determination modules 420 to determine one or more regions in one or more frames 415. Region determination modules 420 may include a multitude of region determination modules such as region determination module 1 (421), region determination module 2 (422), and so forth up to region determination module n (429). Each of the region determination modules may be configured to identify different regions (e g. regions 212, 330, 342, and 222; FIGS. 3A and 3B) in frame(s) 200 (FIGS. 2A and 2B). Each region determination module (421, 422, . . . , and 429) may generate from video 415 region data (431, 432, . . . , and 439 respectively), wherein the region data (431, 432, . . . , and 439) may be encoded by encoder modules 440 at different qualities. For example, region 1 data 431 may be encoded by region 1 encoder module 441 at a first quality, region 2 data 431 may be encoded by region 2 encoder module 441 at a second quality up to region n data 431 may be encoded by region n encoder module 449 at yet a different quality. In some embodiments, it is possible that some region determination modules may process more than one region. It is also possible, that more than one region data (431, 432, . . . , and/or 439) may be encoded at a same or similar quality by different or the same encoder module (441, 442, . . . , and/or 449). The output of the encoder modules 440 may be encoded video 490 that has encoded different regions at different qualities to improve the overall bit rate of the encoded video without decreasing the quality of important elements of the frame, such as a speaker's face.

With continuing reference to FIGS. 2A, 2B and 4, a first region 212 may include a speaker's face. This region 212 may be determined using a region 1 determination module 421. The region 1 determination module 421 may include a face recognition module to locate the speaker's face 210 in a video frame 200. The face recognition module may employ a computer application in combination with computing hardware or other hardware solutions to identify the location of person(s) from a video frame 200. Additionally, the face recognition module may identify the identity of the person(s). One methodology to locate a head in a frame is to detect facial features such as the shape of a head, locations of features such as eyes, mouths, and noses. Example face recognition systems include: Betaface available at betaface [dot] com, and Semantic Vision Technologies available from the Warsaw University of Technology in Warsaw, Poland.

The region 1 determination module 421 may include a face tracking module to track the location of a speaker's face. Using this face tracking module, region 1 may be adjusted to track the speaker's face as the speaker moves around in the frame. Face tracking may use features on a face such as nostrils, the corners of the lips and eyes, and wrinkles to track the movement of the. This technology may use active appearance models, principal component analysis, Eigen tracking, deformable surface models, other techniques to track the desired facial features from frame to frame, combinations thereof, and/or the like. Example face tracking technologies that may be applied sequentially to frames of video, resulting in face tracking include the Neven Vision system (formerly Eyematics, now acquired by Google, Inc.), which allows real-time 2D face tracking with no person-specific training.

According to some of the various embodiments, region determination module(s)s 420 may reassign the first region to include a new speaker's face. This may be accomplished, for example, using extensions to face recognition techniques already discussed. When a face recognition mechanism is employed to locate a head in a frame by detect facial features such as the shape of a head, locations of features such as eyes, mouths, and noses. The features may be compared to a database of known entities to identify specific users. Region determination module(s) 420 may reassign the first region to include a new speaker's face to another identified user when instructed that the other user is speaking. Instructed that another user is speaking may come from a user of the system and/or automatically from the region determination module(s) 420 themselves. For example, some vision based approaches to face recognition may also have the ability to detect and analyze lip and/or tongue movement. By tracking the lip and tongue movement, the system may also be able to identify which speaker is talking at any one time and cause an adjustment in region 1 to include and/or move to this potentially new speaker.

According to some of the various embodiments of the present invention, additional region determination modules may be employed. For example, a third region determination module may identify an area covering additional entities 232, 234, 236, and 238 as a third region 330. This region may be identified using an additional region determination module 422. This module may use similar technologies as the region 2 determination module 422 to identify where the additional participants 232, 234, 236, and 238 reside in the frame(s). Additionally, a fourth region determination module may identify an area covering additional objects 240 and/or like as a fourth region 342. This region may be identified using an automated system configured to identify such objects, and/or the region may be identified by a user. For example, a user may draw a line around a region of the frame to indicate that this area is fourth region 342 (FIGS. 3A and 3B). Alternatively, the presentation may include an object such as a white board which could be identified as a region such as the fourth region 342.

As described earlier, the remainder of the frame (the background) may be identified as a second region 222. To accomplish this, the other regions (e.g. 212, 330, and 342) may be subtracted from the area encompassing the complete frame 200. However, in some embodiments, the background may be determined in other ways. For example, the background may be determined employing a technique such as chroma (or color) keying, employing a predetermined shape, and/or the like. Chroma keying is a technique for compositing (layering) two images or video streams together based on color hues (chroma range). The technique and/or aspects of the technique, however, may be employed to identify a background from subject(s) of a video. In other words, a color range in may be identified and used to create an image mask. In some of the various embodiments, the mask may be used to define a region such as the second (e.g., background) region 222. Variations of chroma keying technique are commonly referred to as green screen, and blue screen. Chroma keying may be performed with backgrounds of any color that are uniform and distinct, but green and blue backgrounds are more commonly used because they differ most distinctly in hue from most human skirt colors. Commercially available computer software, such as Pinnacle Studio, and Adobe Premiere use “chromakey” functionality with greenscreen and/or bluescreen kits.

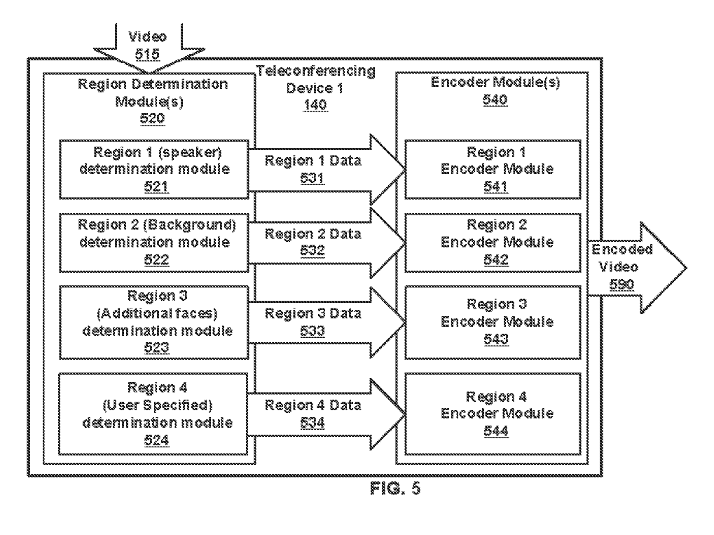

FIG. 5 is a block diagram of another multiple region video conference encoder as per an aspect of an embodiment of the present invention. Specifically, this block diagram illustrates an example teleconferencing device 140 embodiment configured to process a video 515 with up to four regions (212, 222, 330 and 342, FIGS. 3A and 3B). Regional determination modules 520 may process video 515 with four regional determination modules (521, 522, 523 and 524), each configured to identify and process a different region before being encoded by encoder module(s) 540.

Region 1 may be an area 212 covering a primary participant such as an active speaker 210 (FIG. 2A). The region 1 determination module 521 may be configured to identify region 1 areas 212 in video frames 515 and generate region 1 data 531 for that identified region. The region 1 data 531 may be encoded by region 1 encoder module 541 at a first quality level.

Region 2 may be an area 212 covering a background 222 (FIG. 2B). The region 2 determination module 522 may be configured to identify region 2 areas in video frames 515 and generate region 2 data 532 for that identified region. The region 2 data 532 may be encoded by region 2 encoder module 542 at a second quality level.

Region 3 may be an area 330 covering additional entities/participants in a teleconference. The region 3 determination module 523 may be configured to identify region 3 areas in video frames 515 and generate region 3 data 533 for that identified region. The region 3 data 533 may be encoded by region 3 encoder module 543 at a third quality level.

Region 4 may be an area 342 covering additional areas of the video frame 515 such as object(s) of interest 240 (FIG. 2A), a white board, a combination thereof, and/or the like. The region 4 determination module 524 may be configured to identify region 4 areas in video frames 515 and generate region 4 date 534 for that identified region. The region 4 data 533 may be encoded by region 4 encoder module 544 at a fourth quality level.

To reduce the bit-rate of the encoded video, the various region data (531, 532, 533, and 534) may be encoded using different quality levels. A quality level may be indicative of a level of compression. Generally, the lower the level of compression, the higher fee quality of the output stream. Higher levels of compression generally produce a lower bit rate output, whereas, a lower level of compression generally produces a higher bit rate output. In the example of FIG. 5, region 1 data 531 may be encoded at a higher quality than the region 2 data 532, the region 3 data 533, and region 4 data 534. In some of the various embodiments, the region 2 data 532 may be encoded at a higher quality than the region 3 data 533 and region 4 data 534. In some cases, the region 3 data may need to encoded at a higher quality to show an important subject of the teleconference. Therefore, one skilled in the art will recognize that other combinations of quality encoding for different regions may be employed. Additionally, it may be that one or more of the region 1 encoder module 541, region 2 encoder module 542, region 3 encoder module 543, and/or region 4 encoder module 544 may be encoded at a similar and/or same quality level. In some of the various embodiments, one or more of the region 1 encoder module 541, encoder module 542, region 3 encoder module 543, and/or region 4 encoder module 544 may be the same encoder configured to process different regions at different quality levels.

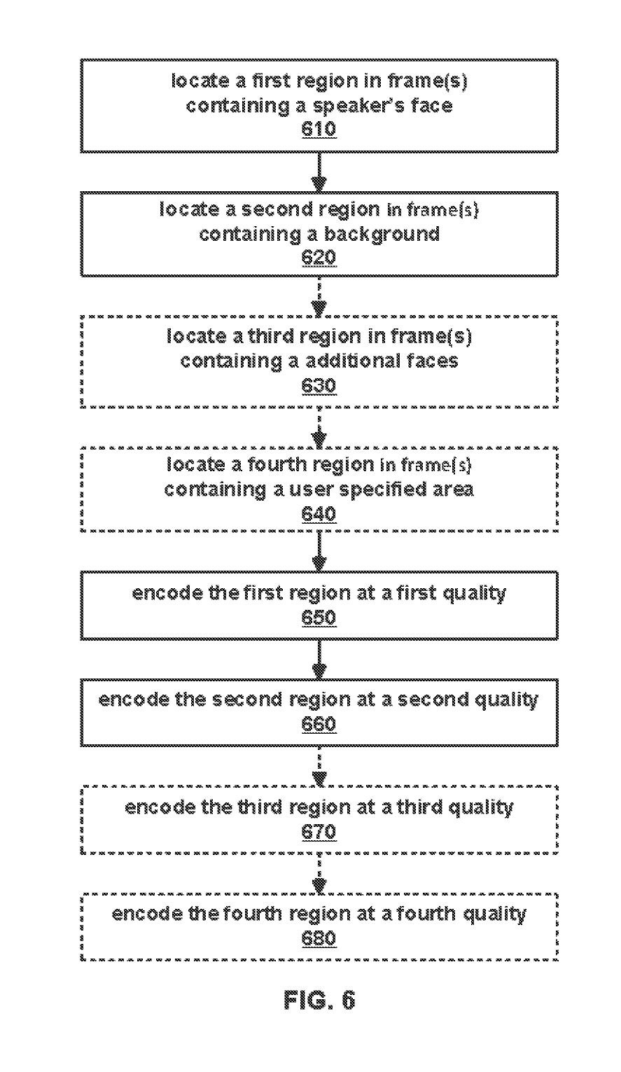

FIG. 6 is a flow diagram of an example multiple region video conference encoding mechanism as per an aspect of an embodiment of the present invention. Blocks indicated with a dashed line are optional actions. The flow diagram may be implemented as a method using hardware and/or software in combination with digital hardware. Additionally, the flow diagram may be implemented as a series of one or more instructions on a non-transitory machine-readable medium, which, if executed by a processor, cause a computer to implement the flow diagram.

A first region of one or more frames containing a speaker's face may be located at 610. Additional regions may be located in the frame. For example: at 630, a third region of the one or more frames containing additional faces may be located; a fourth region of the one or more frames may be located by a user; and at 620 a second region of the one or more frames containing a background may be located. These areas may be located using techniques described earlier.

The first region may be identified employing face recognition techniques described earlier. Face tracking techniques may be employed to adjust the first region to track the speaker's face as the speaker moves around a video frame. Additionally, the first region may be periodically reassigned to a new speaker's face.

Each of the regions may be encoded at different qualities. For example, the first region may be encoded at a first quality at 650, the second region may be encoded at a second quality at 660, the third region may be encoded at a third quality at 670, and the fourth region may be encoded at a fourth quality at 680.

The quality levels may be set relative to each other. For example, the third quality may be lower than the second quality, the second quality may be lower than the first quality, and/or the fourth quality may be lower than the first quality. Various combinations are possible depending upon constraints such as desired final output bit rate, desired image quality of the various regions, combination thereof, and/or the like. In some embodiments, one or more quality levels may be the same. Generally, in video conferencing applications, the quality level of region 1 will be set highest unless another area of the frame is deemed to be more important.

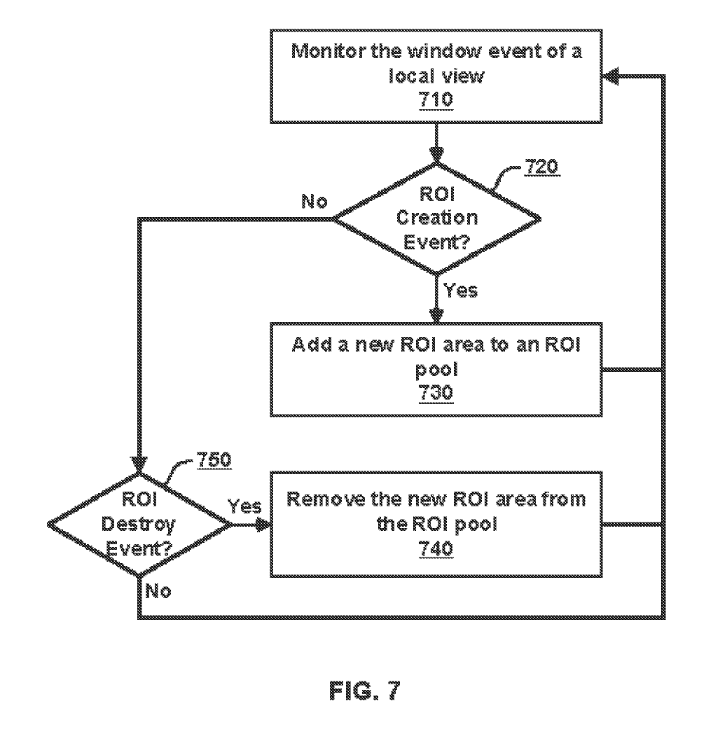

FIG. 7 through FIG. 9 are example flow diagrams of a video conference encoding mechanism as per an aspect of an embodiment of the present invention. Some of the various embodiments of the present invention may decrease the bit-rate of a video conference at the sacrifice of the image quality of unvalued information. Face detection and ROI (region of interest) recognition technology may be combined such that crucial information of a video frame such as attendee faces or user-defined ROI parts may be extracted out and encoded in at high quality level. Since the frame size may become smaller, the bit-rate of the video conference may decrease.

In some embodiments, information in a video frame may be classified into at least 3 types. Each type may be assigned a different quality value according to its importance. In many cases, the frame area which contains the face of the speaker's and the User-Defined ROI may be assigned to be encoded with a highest priority quality level. A secondary level may be assigned to the faces of other attendees. A last level may be assigned to the background of the frame.

For this example, the classification strategy may be based on the typical scenario of a video conference application. The speaker and his action may be the focus of the video conference. The speaker may employ tools such as blackboard or projection screen to help with a presentation. Correspondingly, the some embodiments may detect the speaker's face automatically and the speaker the privilege to define user-defined ROI(s). As audiences, other attendees may contribute less to the current video conference, so they may be assigned to a second level quality. At last, information in the rest area may be roughly static, treated as background and assigned a minimum quality.

An example embodiment may include three modules: an “ROI Demon”, a “Pre-Encoding” module and a “Discriminated Encoding” module. FIG. 7 illustrates the flowchart of a “ROI Demon” module. At the conference local side, the “ROI Creation Event” may be defined as, for example, the constant movement of the mouse on the local view while the “ROI Destroy Event” defined, for example, as double click within a pre-defined ROI area. The demon may maintain the created ROIs, monitor and response to the local view events, provide the ROI creation and destroy service to the user. Specifically, in this example, at processing block 710, window event(s) may be locally monitored. When an ROI creation event is detected at block 720, a new ROI area may be added to an ROI pool. If an ROI destroy event is detected at block 750, the new ROI area may be removed from the ROI pool.

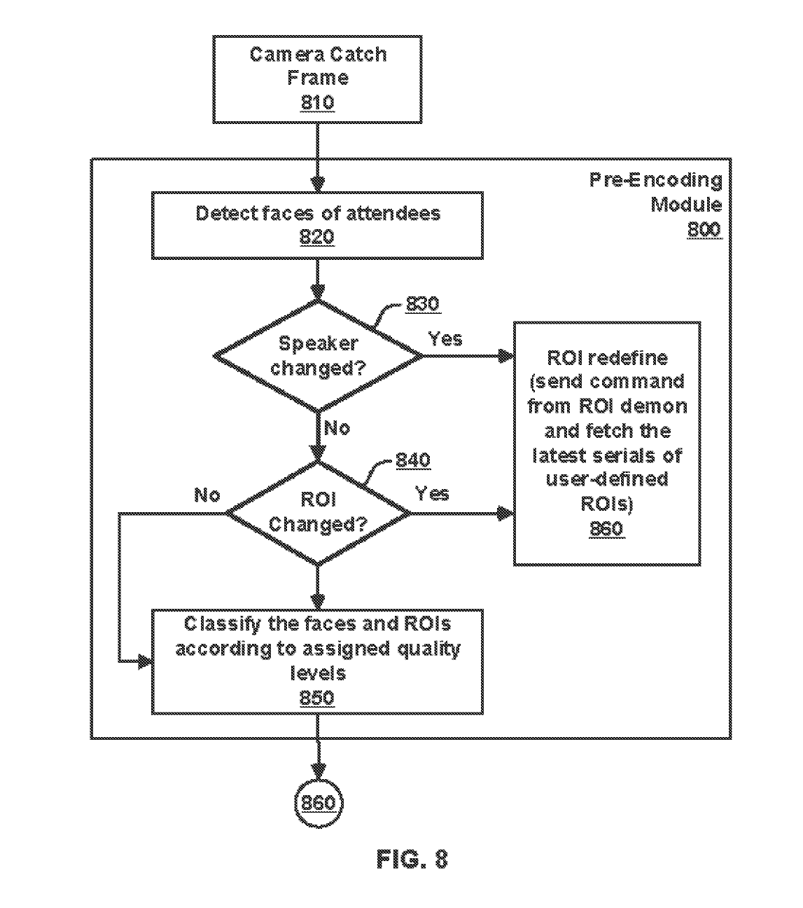

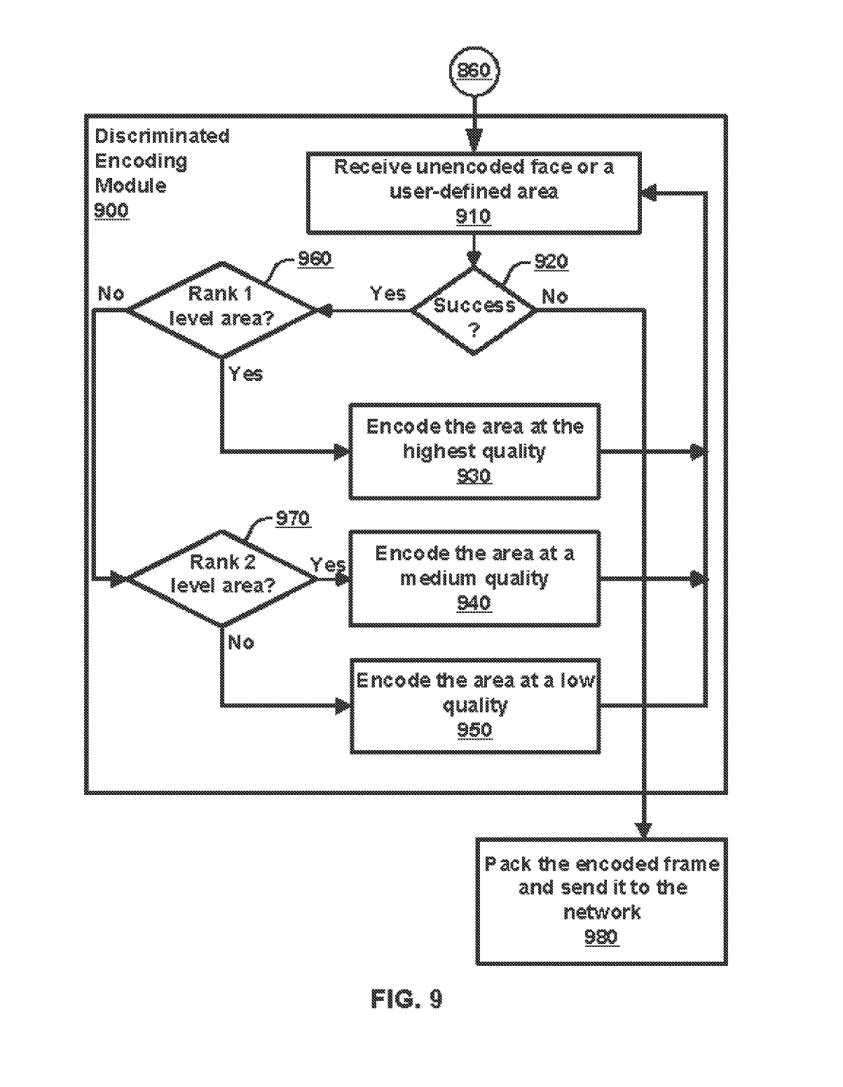

FIG. 8 is a flow diagram of a “Pre-Encoding” module 800 and FIG. 9 is a flow diagram of a “Discriminated Encoding” module 900. The Pre-Encoding module 800 may receive the raw frame from a camera at block 810. By using face analyzing technology, attendee faces may be extracted at block 820. A judgment as to whether the speaker has changed through the tracking of lips movement or expression change may be made at block 830. Besides the initiative change made by the current speaker, if the speaker changes, it may be expected that the speaker may have defined new ROIs and so a check on whether the ROI has changed may be made at block 840. A “ROI Redefine” block 860 may send a request to the “ROI Demon” to ask for the latest User-Defined ROIs. At block 850, faces and ROIs may be classified according to the three quality levels discussed earlier. Classified face and ROI areas from the “Pre-Encoding” module may be communicated to the “Discriminated Encoding” module at block 860 where the classified face and ROI areas may be encoded with the highest, middle and lowest quality respectively.

Unencoded face and/or user-defined area(s) may be received at block 910. If the area is determined to be a level 1 area (e.g. highest priority quality level) at block 960, then it may be encoded at the highest quality level at block 930. If the as a determined to be ranked as a level 2 area (e.g. medium priority quality level) at block 970, then it may be encoded at the medium quality level at block 940. Otherwise, it may be encoded at a low quality level at block 950. This process continues until it is determined at block 920 that all of the faces and areas have been encoded. The encoded frame may then be packed sent to the network at block 980.

This example embodiment may be implemented by modifying an H.264 encoding module to assign different QP (quantization parameter) values to the three types of areas. Experimental results have shown that video output encoded by raw H.264 has a bit-rate is 187 Kbps. However, the video output of a modified H.264 encoder, where the encoding quality of the face area was 1.4 times more than that of the background and the bit-rate had a decreased bit rate from 187 kbps to 127 Kbps. Result represents a 32% improvement to the bit-rate.

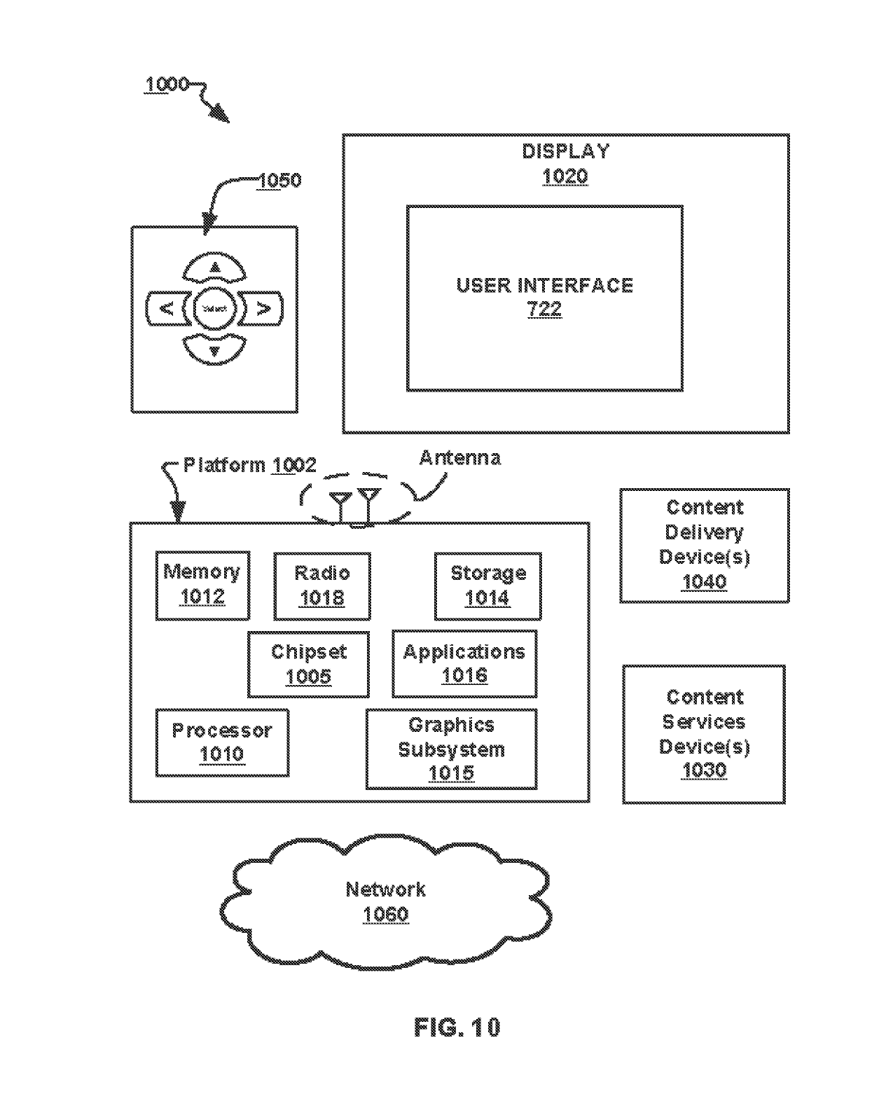

FIG. 10 illustrates an embodiment of a system 1000. In embodiments, system 1000 may be a media system although system 1000 is not limited to this context. For example, system 1000 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 1000 comprises a platform 1002 coupled to a display 1020. Platform 1002 may receive content from a content device such as content services device(s) 1030 or content delivery device(s) 1040 or other similar content sources. A navigation controller 1050 comprising one or more navigation features may be used to interact with, for example, platform 1002 and/or display 1020. Each of these components is described in more detail below.

In embodiments, platform 1002 may comprise any combination of a chipset 1005, processor 1010, memory 1012, storage 1014, graphics subsystem 1015, applications 1016 and/or radio 1018. Chipset 1005 may provide intercommunication among processor 1010, memory 1012, storage 1014, graphics subsystem 1015, applications 1016 and/or radio 1018. For example, chipset 1005 may include a storage adapter (not depicted) capable of providing intercommunication with storage 1014.

Processor 1010 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 1010 may comprise dual-core processor(s), dual-core mobile processor(s), and so forth.

Memory 1012 may be implemented as a volatile memory device such as, but not limited to, a Random Access Memory (RAM), Dynamic Random Access Memory (DRAM), or Static RAM (SRAM).

Storage 1014 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 1014 may comprise technology to increase the storage performance enhanced protection for valuable digital media when multiple hard drives are included, for example.

Graphics subsystem 1015 may perform processing of images such as still or video for display. Graphics subsystem 1015 may be a graphics processing unit (GPU) or a visual processing unit (VFU), for example. An analog or digital interface may be used to communicatively couple graphics subsystem 1015 and display 1020. For example, the interface may be any of a High-Definition Multimedia Interface, DisplayPort, wireless HDMI, and/or wireless HD compliant techniques. Graphics subsystem 1015 could be integrated into processor 1010 or chipset 1005. Graphics subsystem 1015 could be a stand-alone card, communicatively coupled to chipset 1005.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment the functions may be implemented in a consumer electronics device.

Radio 1018 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 1018 may operate in accordance with one or more applicable standards in any version.

In embodiments, display 1020 may comprise any television type monitor or display. Display 1020 may comprise, for example, a computer display screen, touch screen display, video monitor, television-like device, and/or a television. Display 1020 may be digital and/or analog. In embodiments, display 1020 may be a holographic display. Also, display 1020 may be a transparent surface that may receive a visual projection. Such projections may convey various forms of information, images, and/or objects. For example, such projections may be a visual overlay for a mobile augmented reality (MAR) application. Under the control of one or more software applications 1016, platform 1002 may display user interface 1022 on display 1020.

In embodiments, content services device(s) 1030 may be hosted by any national, international and/or independent service and thus accessible to platform 1002 via the Internet, for example. Content services device(s) 1030 may be coupled to platform 1002 and/or to display 1020. Platform 1002 and/or content services device(s) 1030 may be coupled to a network 1060 to communicate (e.g., send and/or receive) media information to and from network 1060. Content delivery device(s) 1040 also may be coupled to platform 1002 and/or to display 1020.

In embodiments, content services device(s) 1030 may comprise a cable television box, personal computer, network, telephone, Internet enabled devices or appliance capable of delivering digital information and/or content, and any other similar device capable of unidirectionally or bidirectionally communicate content between content providers and platform 1002 and/display 1020, via network 1060 or directly. It will be appreciated that the content may be communicated unidirectionally and/or bidirectionally to and from anyone of the components in system 1000 and a content provider via network 1060. Examples of content may include any media information including, for example, video, music, medical and gaming information, and so forth.

Content services device(s) 1030 receives content such as cable television programming including media information, digital information, and/or other content. Examples of content providers may include any cable or satellite television or radio or Internet content providers. The provided examples are not meant to limit embodiments of the invention.

In embodiments, platform 1002 may receive control signals from navigation controller 1050 having one or more navigation features. The navigation features of controller 1050 may be used to internet with user interface 1022, for example. In embodiments, navigation controller 1050 may be a pointing device that may be a computer hardware component (specifically human interface device) that allows a user to input spatial (e.g., continuous and multi-dimensional) data into a computer. Many systems such as graphical user interlaces (GUI), and televisions and monitors allow the user to control and provide data to the computer or television using physical gestures.

Movements of the navigation features of controller 1050 may be echoed on a display (e.g., display 1020) by movements of a pointer, cursor, focus ring, or other visual indicators displayed on the display. For example, under the control of software applications 1016, the navigation features located on navigation controller 1050 may be mapped to virtual navigation features displayed on user interface 1022, for example. In embodiments, controller 1050 may not be a separate component but integrated into platform 1002 and/or display 1020. Embodiments, however, are not limited to the elements or in the context shown or described herein.

In embodiments, drivers (not shown) may comprise technology to enable users to instantly turn on and off platform 1002 like a television with the touch of a button after initial boot-up, when enabled, for example. Program logic may allow platform 1002 to stream content to media adaptors or other content services device(s) 1030 or content delivery device(s) 1040 when the platform is turned “off.” In addition, chip set 1005 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 1002 may establish one or more logical or physical channels to communicate information. The information may include media information aid control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 10.

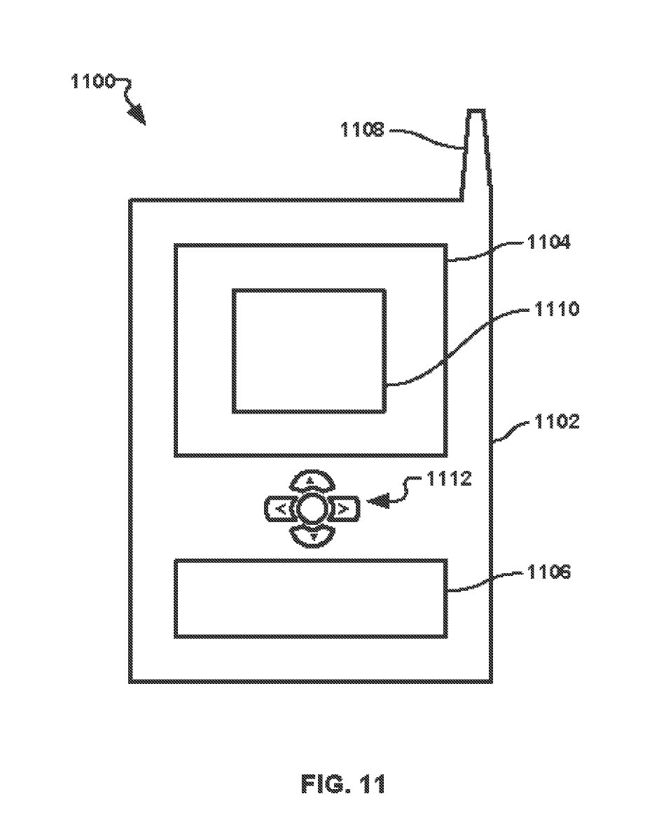

As described above, system 1000 may be embodied in varying physical styles or form factors. FIG. 11 illustrates embodiments of a small form factor device 1100 in which system 1000 may be embodied. In embodiments, for example, device 1100 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palm top computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 11, device 1100 may comprise a housing 1102, a display 1104, an input/output (I/O) device 1106, and an antenna 1108. Device 1100 also may comprise navigation features 1112. Display 1104 may comprise any suitable display unit for displaying information appropriate for a mobile compiling device. I/O device 1106 may comprise any suitable I/O device for entering information into a mobile computing device. Examples for I/O deface 1106 may include an alphanumeric keyboard, a numeric keyboard, a touch pad, input keys, buttons, switches, rocker switches, microphones, speakers, voice recognition device and software, and so forth. Information also may be entered into device 1100 by way of microphone. Such information may be digitized by a force voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, or a combination thereof, all of which are behaviorally equivalent. For example, modules may be implemented using computer hardware in combination with software routine(s) written in a compiler language (such as C, C++, Fortran, Java, Basic, Matlab or the like) or a modeling/simulation program such as Simulink, State flow, GNU Octave, or Lab VIEW MathScript. Additionally it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in anyway.

It is the applicants intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data, similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1-30. (canceled)

31. A system to encode a video conference, comprising:
a camera to capture one or more frames associated with the video conference; and
a teleconferencing device including,
one or more region determination modules to determine in the one or more frames:
a first region to include a speaker's face; and
a second region to include a background; and
one or more encoders to encode:
the first region at a first quality; and
the second region at a second quality, the second quality being less than the first quality.

32. The system according to claim 31, further including a face recognition module to locate the speaker's face.

33. The system according to claim 31, further including a face tracking module to track the location of the speaker's face.

34. The system according to claim 31, wherein:
the one or more region determination modules further define a third region including additional faces; and
the one or more encoders encode the third region at a third quality less than the first quality.

35. The system according to claim 31, wherein:
the one or more region determination modules further define a fourth region specified by a user; and
the one or more encoders encode the fourth region at a fourth quality less than the first quality.

36. An apparatus for encoding video, comprising:
one or more region determination modules to determine in one or more frames:
a first region to include a speaker's face; and
a second region to include a background; and
one or more encoders to encode:
the first region at a first quality; and
the second region at a second quality less than the first quality.

37. The apparatus according to claim 36, further including a face recognition module to locate the speaker's face.

38. The apparatus according to claim 36, further including a face tracking module to track the location of the speaker's face.

39. The apparatus according to claim 36, wherein:
the one or more region determination modules further define a third region including additional faces; and
the one or more encoders encode the third region at a third quality less than the first quality.

40. The apparatus according to claim 36, wherein:
the one or more region determination modules further define a fourth region specified by a user; and
the one or more encoders encode the fourth region at a fourth quality less than the first quality.

41. The apparatus according to claim 36, wherein the one or more region determination modules reassign the first region to include a new speaker's face.

42. A method of encoding video, comprising:
locating a first region of one or more frames containing a speaker's face;
locating a second region of the one or more frames containing a background;
encoding the first region at a first quality; and
encoding the second region at a second quality.

43. The method according to claim 42, further including:
locating a third region of the one or more frames containing additional faces; and
encoding the third region at a third quality.

44. The method according to claim 42, further including:
locating a fourth region of the one or more frames defined by a user; and
encoding the fourth region at a fourth quality.

45. The method according to claim 44, wherein the fourth quality is lower than the first quality.

46. The method according to claim 43, wherein the third quality is lower than the second quality.

47. The method according to claim 42, further including defining the first region using face recognition.

48. The method according to claim 42, further including adjusting the first region to track the speaker's face.

49. The method according to claim 42, further including reassigning the first region to a new speaker's face.

50. The method according to claim 42, wherein encoding employs MPEG compression.

51. The method according to claim 42, wherein the second quality is lower than the first quality.

52. An apparatus for encoding video, comprising:
means for locating a first region of one or more frames containing a speaker's face;
means for locating a second region of the one or more frames containing a background;
means for encoding the first region at a first quality; and
means for encoding the second region at a second quality.

53. The apparatus of claim 52, further including:
means for locating a third region of the one or more frames containing additional faces; and
means for encoding the third region at a third quality.

54. The apparatus of claim 52, further including:
means for locating a fourth region of the one or more frames defined by a user; and
means for encoding the fourth region at a fourth quality.

55. The apparatus of claim 54, wherein the fourth quality is lower than the first quality.

56. The apparatus of claim 53, wherein the third quality is lower than the second quality.

57. The apparatus of claim 52, further including means for defining the first region using face recognition.

58. The apparatus of claim 52, further including means for adjusting the first region to track the speaker's face.

59. The apparatus of claim 52, further including means for reassigning the first region to a new speaker's face.

60. The apparatus of claim 52, wherein the second quality is lower than the first quality.
